(19) United States
(12) Patent Application Publication
(10) Pub. No.: US 2008/0129030 A1
(43) Pub. Date: Jun. 5, 2008

(54) Device for Assisting Grasping of a Safety Belt and Motor Vehicle Equipped with Same

(76) Inventor: Daniel Nonat, Epinay Sous Senart (FR)

Correspondence Address: MILLER, MATTHIAS & HULL, ONE NORTH FRANKLIN STREET, SUITE 2350, CHICAGO, IL, 60606, US

(21) Appl. No.: 12/016,059

(22) Filed: Jan. 17, 2008

(30) Foreign Application Priority Data
Jul. 29, 2005 (FR) 05 08164

(51) Int. Cl. B60R 22/00

(52) U.S. Cl. 280/808; 280/801.1; 297/481

(57) ABSTRACT

The invention concerns a device for assisting gripping of the safety belt comprising: a base fixed to the passenger compartment; a flexible tube extending between a first end supported by the base and a second closed end connected to the safety belt. The tube extends under the effect of a compressed gas, between its first end and its second end retained by said belt while it is being inflated until it reaches its gripping position wherein a passenger can catch the tube to pull towards him/her the safety belt.

### CROSS-REFERENCE TO RELATED APPLICATIONS

This application is a U.S. national stage filing of International Patent Application No. PCT/FR2006/001802 filed on Jul. 24, 2006, which claims priority under the Paris Convention to French Patent Application No. 0 508164, filed on Jul. 29, 2005.

### BACKGROUND OF THE DISCLOSURE

The present invention relates to devices for assisting the grasping of a safety belt, and motor vehicles fitted with such devices.

### SUMMARY OF THE DISCLOSURE

More particularly, the invention relates mainly to a device for assisting the grasping of the safety belt of a motor vehicle comprising a passenger compartment, said assisting device comprising:
a base designed to be fixed to the passenger compartment;
an extensible flexible tube extending between a first end carried by the base and a second closed end connected to the safety belt,
   the first end being designed to receive a compressed gas at a pressure greater than the atmospheric pressure.

The document EP-A-0,149,728 describes an example of such an assisting device. However, such an assisting device is difficult to implement. In fact, a large force must be generated to move the safety belt which, conventionally, is subject to the action of a seat belt retractor in its rest position. In this document it is therefore a case of using elements able to withstand high levels of stress. For example, the base will be directly attached to the rigid structure of the passenger compartment of the vehicle, which adversely affects the integrity of the passenger compartment, which is clearly detrimental to the safety of the occupant.

The object of the present invention is in particular to overcome these disadvantages.

To achieve this, according to the invention, an assisting device of the type in question is characterized in that the tube is designed to deploy due to the effect of said compressed gas, between its first end and its second end retained by said belt during the inflation, until it reaches a grasping position in which an occupant can get hold of the tube to pull the safety belt to him.

Owing to these arrangements, it is not really a question of moving the safety belt, but of providing the occupant with a harness on which he can pull to bring the belt to him. Consequently, such an assisting device can be fitted into the passenger compartment without compromising the structural integrity of the vehicle, even so as to be removable. Being light (for example weighing less than 100 grams), the system can be supplied with power from the electrical circuit of the vehicle.

In preferred embodiments of the invention, it is also possible to use one or more of the following arrangements:
the tube is an elastically extensible flexible tube, the tube extending elastically due to the effect of the compressed gas;
the device comprises a gas supply system leading to said first end to deliver the gas to it;
the gas supply system has an end near said first end of the tube, said end being angled;
the base carries an orienting device to which the first end of the tube is connected, the orientation and/or the torsion of the first end in relation to the base being adjustable at the orienting device;
the tube has an elastic extension equal to at least 200%, preferably equal to at least 300%;
the device comprises a compressed gas generating system;
the compressed gas generating system comprises:
a compressor designed to deliver a compressed gas in the direction of the first end of the tube,
a solenoid valve which can have a closed condition in which the gas is retained in the tube, and an open condition in which the retained gas is released to the outside, and
a control unit designed to control the compressor to deliver the compressed gas to the tube, and move the solenoid valve to its closed condition to retain the gas in the tube;
the control unit includes:
a receiver designed to receive a triggering instruction from a user, the receiver being designed to switch on the compressor, and
a timer, the timer being designed to control the opening of the solenoid valve at the end of a time at which a sufficient deployment of the tube has been obtained;
the receiver is a radio receiver, and the control unit includes a radio transmitter cooperating with the radio receiver, and able to be operated by the user to transmit a control signal to the radio receiver;
the compressed gas generating system is designed to be supplied with electric power from the electrical circuit of the vehicle.

According to another aspect, the invention relates to a motor vehicle comprising a passenger compartment, at least one motor vehicle seat, a safety belt for the seat, at least one such assisting device, of which the base is fixed to the passenger compartment and the second end of the tube is connected to the safety belt.

In some embodiments, it is also possible to utilize one or more of the following features:
the passenger compartment includes a rigid structure and the base is fixed to the rigid structure so as to be removable;
the passenger compartment includes an inner side pillar next to the vehicle seat, said vehicle seat being oriented toward the front, the base is fixed to the inner side pillar, a first portion of the tube including the first end is oriented mainly toward the front, and in its rest position, the tube extends mainly downward to its second end connected to the belt,
in the inflated position, the tube is located in a position further forward than its rest position;
the first portion of the tube is also oriented sideways toward the outside of the vehicle;
the safety belt includes a buckle resting on a stop, and the second end of the tube includes a strap guide through which the safety belt passes, said strap guide resting on the buckle when the safety belt is unfastened.

### BRIEF DESCRIPTION OF THE DRAWINGS

Other features and advantages of the invention will emerge in the course of the following description of one of its embodiments, given as a non-limiting example, with reference to the attached drawings.

In the drawings:

FIG. 1 is a schematic side view of a motor vehicle, taken from inside the vehicle;

FIG. 2 is a schematic side view of an assisting device of which the tube is in the rest position (unbroken line) and in the grasping position (broken line);

FIG. 3 is a diagram representing a compressed gas generating system; and

FIG. 4 is a schematic view corresponding to FIG. 1 when the safety belt is fastened.

In the various figures, identical or similar elements are indicated by the same numbers.

### DETAILED DESCRIPTION OF THE DISCLOSURE

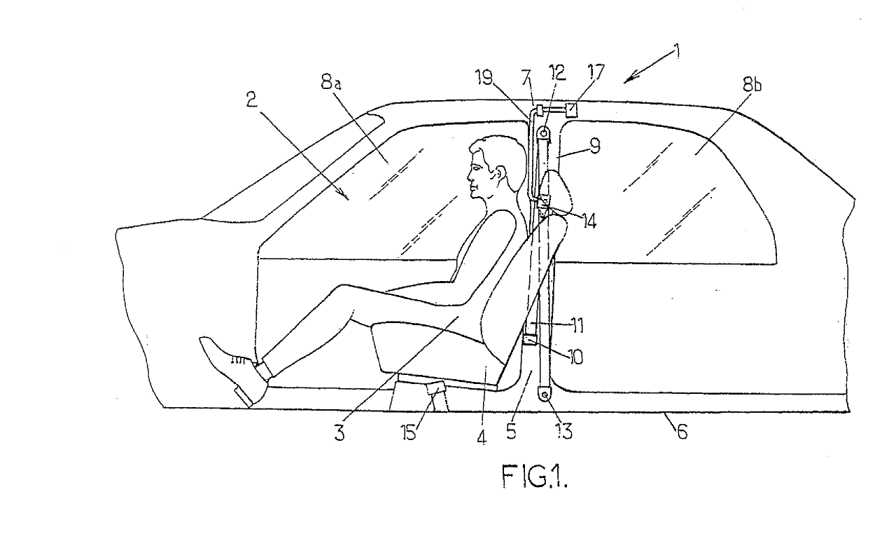

FIG. 1 illustrates a motor vehicle 1, seen in side view taken for example from inside the vehicle, for example from a left-hand front seat of the vehicle. Such a motor vehicle usually includes a passenger compartment 2 in which the occupant 3 of the motor vehicle can take a seat, sitting on a seat 4 of the vehicle. Such a passenger compartment 2 is usually made from a rigid steel structure comprising for example a metal pillar 5 illustrated schematically in FIG. 1 extending from the floor 6 to the roof 7 of the vehicle between the windows 8a, 8b of the vehicle.

Such a pillar 5 can be covered with a plastic or textile or other trim 9, which forms the inner wall of the vehicle visible to the occupant 3.

The passenger compartment 2 also includes a safety belt module for the seat of the vehicle 4, which includes a safety belt receptacle 10 from which a safety belt 11 extends to an upper anchorage point 12 attached to the pillar 5, then a lower anchorage point 13 located generally on the vertical from the upper anchorage point 12. The safety belt 11 carries a buckle 14 designed to be clamped in a safety belt stalk 15 located on the opposite side of the seat, so as to retain the occupant 3 in the seat in the event of an automobile accident. The buckle 14 is retained in position by a stop not visible in FIG. 1, in a known manner.

In the non-fastened position of the safety belt 11, illustrated in FIG. 1, a seat belt retractor disposed in the receptacle 10 pulls the safety belt 11 taut along the inner wall of the passenger compartment 2.

The pillar 5 receives a device for assisting the grasping of the safety belt 11, which will be described in more detail later.

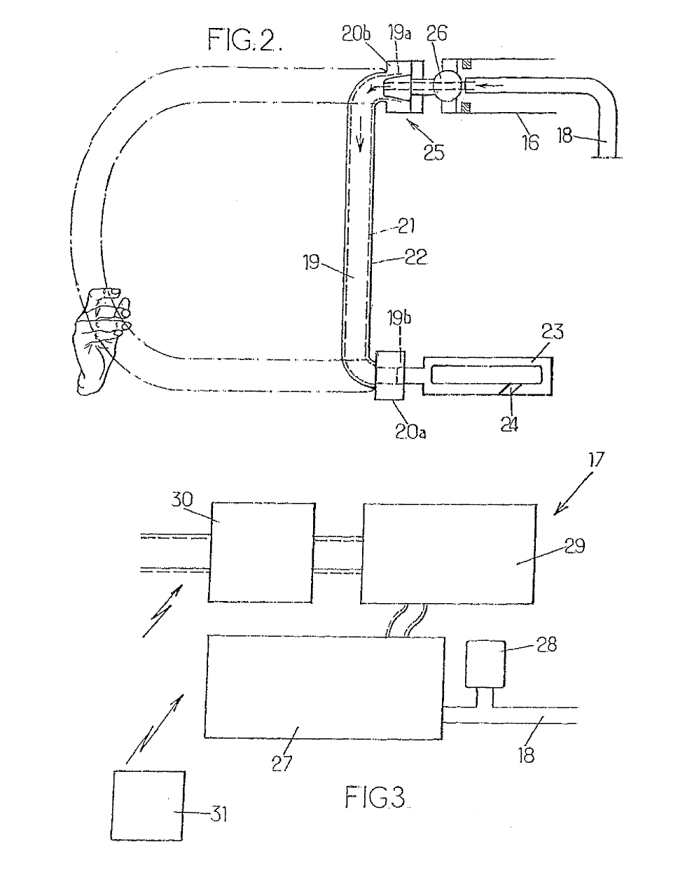

As illustrated in FIG. 2, the assisting device includes a base 16 designed to be fixed to the pillar, without compromising its structural integrity. For example, the base 16 could be made magnetic to be fitted directly to a metal inner wall of the vehicle. A system of attachment by gluing can also be envisaged. The base 16 can also be screwed to or hooked on a plastic trim of the interior of the vehicle. Such systems of attachment make it possible to envisage making the base 16 so as to be removable, for example in order to adjust its position in the vehicle, or even to render the assisting device capable of being installed in various vehicles. The base 16 receives a compressed gas, such as compressed air, from a compressed gas generating system 17 of which an example will be described later in more detail with reference to FIG. 3.

The compressed gas arriving at the base 16 from a gas supply pipe 18 is sent to a tube 19, which extends from a first end 19a in fluid connection to the end of the gas supply pipe 18, and a second end 19b closed for example by a second end plastic end piece 20a. The tube 19 is made from a flexible material, bendable but strong, having an elastic extension equal to at least 200%, and preferably equal to at least 300%, designed to extend elastically due to the effect of the compressed gas supply.

It is arranged for example to make the tube 19 from an inner latex air chamber 21 lined with an outer extensible textile sheath 22 made for example in the form of a tubular sheath woven on a shuttle loom (seamless) composed of textile threads woven with latex threads incorporated longitudinally to provide an adequate extensibility.

Such a sheath 22 protects the latex air chamber 21 from ultraviolet radiation. The completed prototype, with a thickness of 0.6 millimeters, diameter 12/6, produces a tube 19 of very low weight, having an elastic extension of 280%, with a service life equal to at least 5000 cycles.

It can also be arranged to cover the sheath 22 with an anti-ultraviolet cover (not illustrated) protecting the latex threads of the sheath 22 from ultraviolet rays.

This cover is for example made of an ultralight slightly extensible textile having the length of the tube 19 when extended. When the tube is at rest, the cover then looks like the bellows of an accordion, its “swelling” providing a barrier of thermal protection for the tube.

The length of the tube at rest is determined according to the following criteria:
extension toward the front of a given value, for example of the order of 280 mm to 350 mm, necessary to meet the expected assistance requirement; and
at-rest dimension being compact for the user.

Depending on the length of the tube, the extensibility is determined according to the following criteria:
sufficient to obtain the desired extension;
enabling sufficient pressurization for the grasping.

However, the invention is not limited to the embodiment presented here, and any materials could be used to constitute the tube 19 which produce the desired level of elastic extension, a given durability, and/or a satisfactory elastic return to the rest condition.

The second end 19b of the tube is closed, by the end piece 20a, which carries a strap guide 23 through which the safety belt 11 passes via the opening 24. The strap guide 23 rests on the safety belt buckle 14, itself resting on a stop. In order to ensure a sufficiently high position of the buckle, when installing the assisting system here described in a vehicle, in which the buckle is conventionally retained quite low by a stop, it can be arranged to add, above the existing stop, a sufficiently high stop, on which rests the buckle which, itself, supports the strap guide.

The base 16 is fixed in the vehicle so that the first portion, including the first end 19a of the tube, is oriented at least toward the front of the vehicle in the direction of the occupant 2.

When the compressed air arrives via the gas supply pipe 18, the tube 19 extends to the grasping position illustrated by the broken line in FIG. 2, in which the occupant 3 can get hold of the tube 19 to pull the safety belt to him. During the inflation, the tube 19 hardly moves the safety belt 11, which remains taut due to the effect of the seat belt retractor. Consequently, the second end 19b is generally retained by the belt 11 during the inflation.

As illustrated in FIG. 2, the assisting device can also include an orienting device 25 carried by the base 16, for example made in the form of a ball joint 26 which can rotate in relation to the base 16, and held in place by friction on it during the inflation. Of course, the ball joint 26 has a hole through it to maintain the fluid connection between the pipe 18 and the tube 19.

This orienting device 25 allows each user to position the assisting device in the vehicle 1 to suit him. This makes it possible to obtain, during the inflation, a geometric extension of the tube in space which is best for the user.

In fact, the base 16 can be fixed close to the roof 7 of the vehicle. Because the shape of the inner wall of the passenger compartment is usually curved inward, the tube 19 would be likely to collide with the occupant 3 during the inflation. To prevent this, it can be arranged that the first portion including the first end 19a of the tube 19 will be oriented slightly sideways toward the outside, for example by making the connection between the gas supply pipe 18 and the tube 19 such that it is angled toward the outside, in order to allow the deployment of the tube 19 in the best way between the occupant 3 and the inner wall of the passenger compartment.

On the other hands due to the natural elasticity of the latex forming the air chamber 21, and the way in which it is fixed to the end pieces 20a and 20b, the inflation may cause a slight twisting of the tube 19 so that it does not inflate directly toward the front, but deploys slightly sideways during the inflation. To compensate for this lateral deviation, the orienting device can undergo a rotation (torsion) about the longitudinal axis of the tube in relation to the base. Thus, the positioning of the end piece can be adjusted to generate in the tube a torsion opposing the natural twisting of the tube when it deploys, and compensate for the natural deviation observed.

The end pieces can be made of plastic so as not to damage the tube by cutting.

In place of the orienting device illustrated in FIG. 2, a direct fixed connection could simply be arranged between the flexible gas supply pipe 18 and the tube 19.

As illustrated in FIG. 3, the compressed gas generating system 17 can be made as a small unit with its outlet connected to the gas supply pipe 18 delivering the compressed air to the tube 19.

The compressed gas generating system 17 comprises a compressor 27 or an air pump capable of providing a pressure of at least 1.5 bar at a flow rate of at least 3 liters per minute. Preferably, a compressor 27 will be selected which can be supplied with power from the electrical system of the vehicle, if necessary via a transformer, for example connected to the cigarette lighter of the vehicle, or connected in any other suitable manner to the electrical circuit of the vehicle. Such a compressor is for example a RIETSCHLE THOMAS compressor, selected for its reliability and its compactness. The system 17 also comprises a discharge solenoid valve 28 (for example made by KOGE) which can have a closed condition or an open condition, in which the compressed air present in the tube is discharged to the outside. The system 17 can also comprise a timer 29 and a receiver 30 designed to receive a command from the occupant 3 of the seat. The receiver 30 is for example a radio receiver communicating with a radio transmitter 31 controlled by the occupant 3.

The system which has just been described works as follows.

When the occupant 3 desires to utilize the assisting device, he sends a command from the radio transmitter 31 to the radio receiver 30 which triggers the operation of the compressor 27, and the closing of the solenoid valve 28. The radio receiver 30 also switches on the timer 29, which is designed to open the solenoid valve 28 at the end of a certain given preprogrammed time, which is the time at the end of which a sufficient pressure is obtained in the tube, in practice a few seconds. Due to the action of the compressor, the air is delivered to the tube 19 which deploys and extends, due to the effect of the compressed air, its second end 19b remaining generally in place during the inflation, due to the tension of the safety belt 11, and the fact that the strap guide 23 rests on the safety belt buckle 14, which itself rests on the stop, in a known manner. In the grasping position illustrated in FIG. 2, by the broken line, the occupant 3 can get hold of the tube 19 which has arrived in the grasping position at his side, without having to turn round in his seat or make too much of an effort, and pull the tube 19 to him, which also brings with it the safety belt 11 connected to the tube by means of the strap guide 23.

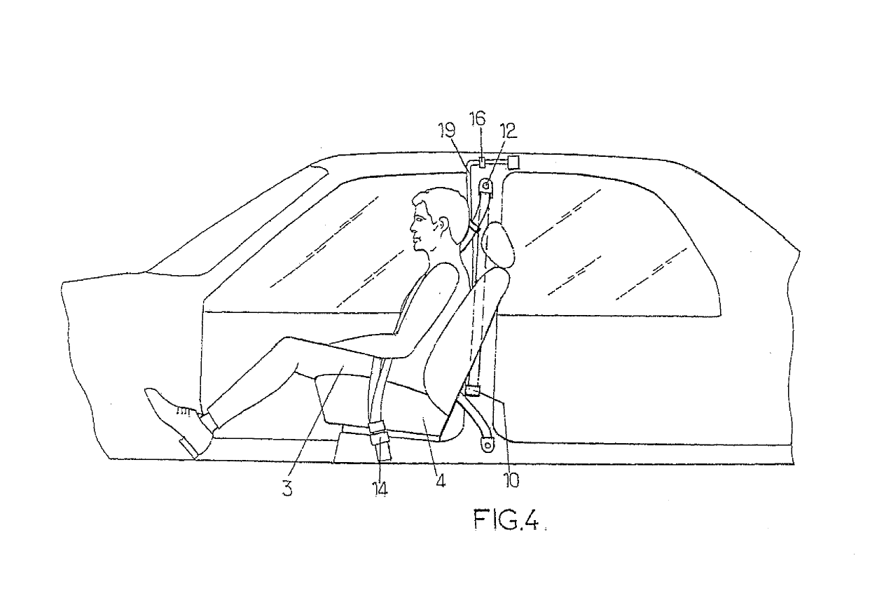

Then being able to get hold of the belt, the occupant 3 can fasten it, as illustrated in FIG. 4. At that moment, the timer interrupts the electric power supply, which commands both the stopping of the compressor and the opening of the solenoid valve so that the tube 19 deflates, and returns automatically to the rest position illustrated in FIG. 4, without getting in the way of the occupant 3 in this position.

The mechanical effect of the extensibility of the sheath alone makes it return to the rest position, going back up the belt with the strap guide while the user fastens his belt.

It will be noted that the timer could, in a variant, be designed to cut off, firstly the power supply to the compressor then, secondly, that to the solenoid valve.

The same compressed air generating system can also be used to provide the assistance for the grasping of the safety belt to other occupants of the vehicle, for example using a multiway valve 28, and two-way or multichannel transmitter/receivers.

It will be noted that as an alternative to the extensible flexible tube described, a non-extensible flexible tube could be used, for example made of flexible plastic sleeves, forming a loop hanging along the inner wall in the rest position, and tensed while deploying due to the effect of the compressed gas.

It will be noted that the system offers great freedom of choice, because the occupant is free to use or not use the assisting device.

1. A device for assisting the grasping of the safety belt of a motor vehicle comprising a passenger compartment, said assisting device comprising:
a base designed to be fixed to the passenger compartment;
a flexible tube extending between a first end carried by the base and a second closed end connected to the safety belt;
the first end being designed to receive a compressed gas at a pressure greater than the atmospheric pressure, wherein the tube is designed to deploy due to the effect of said compressed gas, between its first end and its second end retained by said belt during the inflation, until it teaches a grasping position in which an occupant can get hold of the tube to pull the safety belt to him

2. The assisting device as claimed in claim 1, in which the flexible tube is an elastically extensible flexible tube, the tube extending elastically due to the effect of said compressed gas.

3. The assisting device as claimed in claim 1, also comprising a gas supply system leading to said first end to deliver the gas to it.

4. The assisting device as claimed in claim 3, in which the gas supply system has an end near said first end of the tube, said end being angled

5. The assisting device as claimed in claim 1, in which the base carries an orienting device to which the first end of the tube is connected, the orientation and/or the torsion of the first end in relation to the base being adjustable at the orienting device.

6. The assisting device as claimed in claim 2, in which the tube has an elastic extension equal to at least 200%, preferably equal to at least 300%.

7. The assisting device as claimed in claim 1, also comprising a compressed gas generating system.

8. The assisting device as claimed in claim 7, in which the compressed gas generating system comprises:
a compressor designed to deliver a compressed gas in the direction of the first end of the tube;
a solenoid valve which can have a closed condition in which the gas is retained in the tube, and an open condition in which the gas is released to the outside; and
a control unit designed to control the compressor to deliver the compressed gas to the tube, and move the solenoid valve to its closed condition to retain the gas in the tube.

9. The assisting device as claimed in claim 8 in which the control unit includes:
a receiver designed to receive a triggering instruction from a user, the receiver being designed to switch on the compressor; and
a timer, the timer being designed to control the opening of the solenoid valve at the end of a time at which a sufficient deployment of the tube has been obtained.

10. The assisting device as claimed in claim 9 in which the receiver is a radio receiver, and in which the control unit includes a radio transmitter cooperating with the radio receiver, and able to be operated by the user to transmit a control signal to the radio receiver.

11. The assisting device as claimed in claim 7 in which the compressed gas generating system is designed to be supplied with electric power from the electrical circuit of the vehicle.

12. A motor vehicle comprising a passenger compartment, at least one motor vehicle seat, a safety belt for the seat, and at least one assisting device as claimed in claim 1, of which the base is fixed to the passenger compartment and the second end of the tube is connected to the safety belt.

13. The vehicle as claimed in claim 12, in which the passenger compartment includes a rigid structure and in which the base is fixed to the rigid structure so as to be removable.

14. The motor vehicle as claimed in claim 12, in which the passenger compartment includes an inner side pillar next to the vehicle seat, said vehicle seat being oriented toward the front, in which the base is fixed to the inner side pillar, in which a first portion of the tube including the first end is oriented mainly toward the front, and in its rest position, the tube extends mainly downward to its second end connected to the belt, in which in the grasping position, the tube is located in a position further forward than its rest position.

15. The motor vehicle as claimed in claim 14, in which the first portion of the tube is also oriented sideways toward the outside of the vehicle

16. The motor vehicle as claimed in claim 12, in which the safety belt includes a buckle resting on a stop, and in which the second end of the tube includes a strap guide through which the safety belt passes, said strap guide resting on the buckle when the safety belt is unfastened.
